(19) United States
(12) Patent Application Publication
(10) Pub. No.: US 2016/0003467 A1
(43) Pub. Date: Jan. 7, 2016

(54) Hair Band Device Having Function of Illumination

(71) Applicant: Hua-Cheng Pan, Tainan City (TW)

(72) Inventor: Chih-Liang Wang, Tainan City (TW)

(21) Appl. No.: 14/322,932

(22) Filed: Jul. 3, 2014

(51) Int. Cl. F21V 33/00; A45D 8/36; F21V 23/04

(52) U.S. Cl. CPC F21V 33/0008; F21V 23/0414; A45D 8/36; F21Y 2101/02

(57) ABSTRACT

A hair band device with function of illumination is provided. The hair band device comprises a hair band body and a light emitting member. A bottom base is combined with the hair band body. A switch is configured to the bottom base for selectively energizing and de-energizing light emitting device. When the light emitting device inside housing of the light emitting member is activated, the hair band device can emit light for illuminating.

### TECHNICAL FIELD

The present invention generally relates to a hair band, more particularly, to a hair band device having function of illumination, which is embedded with light emitting device.

### BACKGROUND

Hair band is typically made of metals, metal alloys or plastic materials. From the viewpoint of weight reduction, plastic materials are employed for production of the hair band.

Hair bands are a common article for modern women to take care of their hair and to achieve an ornamentation purpose. A conventional hair band is substantially an arcuate piece integrally formed of flexible material by heat pressing and a surface thereof is treated by baked finish, gold plating, etc, thereby providing an attractive appearance. Nevertheless, the manufactures have to produce at least three sizes for each specific appearance of the hair hands to meet users having different sizes of heads (e.g., for children and adults), resulting in an increase in the cost. In addition, the hair bands become very personal, i.e., a hair band fitting a person may not fit another as a length thereof is not adjustable.

As described above, the invention proposes a newly concept and function of hair band different from conventional hair bands. Accordingly, there is a possibility that the invention's hair band is superior to prior art's hair bands.

### SUMMARY

According to an aspect of the invention, it proposes a hair band device with function of illumination, comprising a hair band body, with two ends and hair retaining portion; a light emitting member fixed on said hair band body, wherein the light emitting member comprises a base, a light emitting device for emitting light and a housing, wherein the light emitting device is disposed on the base and the housing with transparent or translucent property surrounds the light emitting device; and a switch coupled to said light emitting member for selectively power on and power off light emitting device of the light emitting member.

In an aspect, the hair band further comprises a decoration unit disposed between the hair band body and the light emitting member. The light emitting member is a lamp. The light emitting device is a light emitting diode.

In another aspect, the hair band further comprises a bottom base with a circuit board disposed on the bottom base, wherein the circuit board includes a control circuit for controlling the light emitting device.

In yet another aspect, the hair band device further comprises a buzzer disposed on the bottom base for coupling to the circuit board.

In one aspect, the hair band device further comprises a rock switch for coupling to the circuit board. The rock switch is ball-rolling switch, vibration ball switch or contact type vibration switch.

In another aspect, the hair band device further comprises a music IC for coupling to the circuit board.

In yet another aspect, the control circuit is an integrated circuit and is programmed with one or more patterns for flashing and/or maintaining illumination of the light emitting devices. The bottom base includes a battery compartment. A battery may be disposed on the battery compartment. A bottom cover may be combined with or detachable from the bottom base.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a perspective view of a hair band device having function of illumination according to the invention;

FIG. 2 illustrates an expanded view of a hair band device according to one embodiment of the invention;

FIG. 3 and FIG. 4 illustrate an expanded view of the bottom base of the FIG. 2.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The present invention provides a hair band device having function of illumination, which is equipped with light emitting member. Purpose of the invention proposes a hair band device equipped with light emitting device capable of showing function of illumination. The hair band device comprises a hair band body having two ends and hair retaining portion, and a light emitting member or light emitting module.

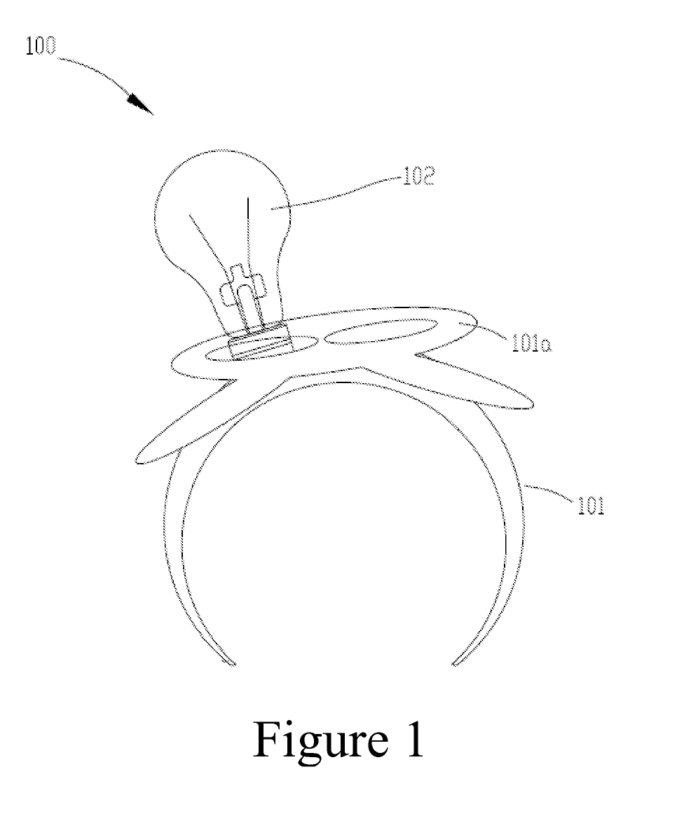

FIG. 1 shows a perspective view of a hair band device having function of illumination according to the invention. As shown in FIG. 1, a hair band device 100 includes a hair band body 101 and light emitting member 102 fixed (disposed) on the hair band body 101. For example, the hair band body 101 is made to be a desired pattern (figure) hair band. The hair band device 100 further comprises a decoration unit 101a disposed between the hair band body 101 and the light emitting member 102. The decoration unit 101a may be made by color tulle, or color grenadine. The decoration unit 101a is fixed on the hair band body 101.

In one embodiment, the hair band body 101 has two ends and hair retaining portion. The two ends and hair retaining portion of the hair band body 101 may have a first curvature and a second curvature, respectively. The two ends and hair retaining portion of the hair band body 101 may be integrally made. The two ends and hair retaining portion of the hair band body 101 may be attached to each other.

For example, the light emitting member 102 is a lamp which may include one or more light emitting diodes, or another type of light emitting unit or device. In one embodiment, the lamp 102 comprises a base, light emitting device for emitting light, lampshade housing, wherein the light emitting device is disposed on the base and the lampshade housing surrounds the light emitting device. The light emitting device includes one or more light emitting diodes. The base has a coupling portion for the LEDs mounted on the base. In one embodiment, the lamp further comprises a circuit board coupled with the coupling portion.

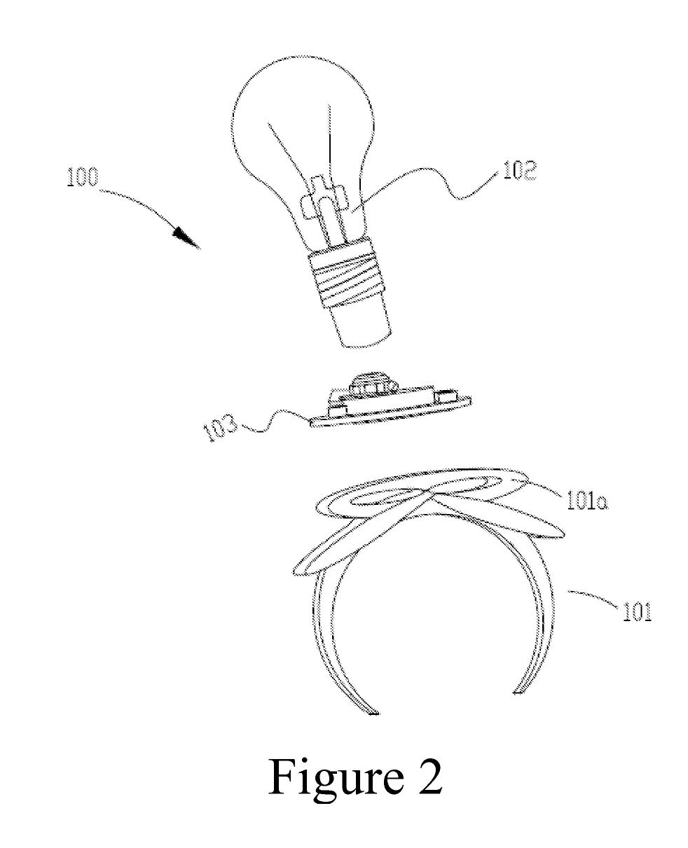

FIG. 2 illustrates an expanded view of a hair band device according to one embodiment of the invention. In this embodiment, as shown in FIG. 2, a hair band device 100 includes a hair band body 101 with decoration unit 101a fixed thereon, light emitting member 102, and a bottom base 103. The light emitting member 102 is for fixing on and coupling to the bottom base. The bottom base 103 is fixed onto the hair band body 101. For example, the hair band body 101 is made to be a desired pattern (figure) hair band. The bottom base 103 is disposed between the decoration unit 101a (hair band body 101) and the light emitting member 102.

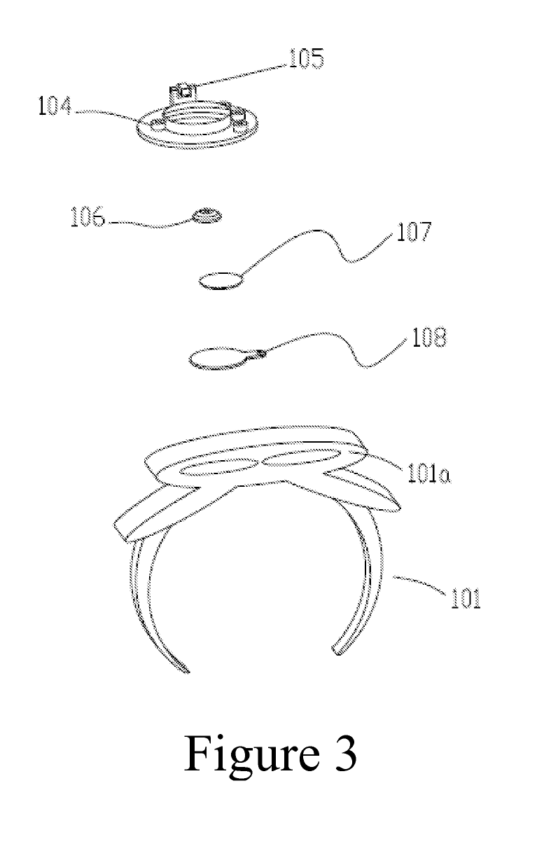

The bottom base 103 is used for carrying the light emitting member. The bottom base 103 includes a circuit board 104 and a switch 105, shown in FIG. 3. In one embodiment, the circuit board 104 is disposed on the bottom base 103. In one embodiment, the circuit board 104 is coupled to light emitting device of the light emitting member 102. In one embodiment, the circuit board 104 includes a control circuit for controlling light emitting device of the light emitting member 102. The light emitting device of the light emitting member 102 is activated by the control circuit. The control circuit may be disposed/configured on the circuit board 104. The circuit board 104 is for example a printed circuit board. The switch 105 may be interposed between a power source 107 and light emitting device of the light emitting member 102, which is activatable by a user. The switch 105 may be coupled to the circuit board 104 for switching on/off state of the light emitting device of the light emitting member 102. In one embodiment, the circuit board 104 may be integrated into the base of the light emitting member 102, and the switch 105 may be integrated onto the base of the light emitting member 102, for coupling to the light emitting device. The circuit board 104 is electrically connected to the power source 107, such as battery. In one embodiment, the circuit board 104 is electrically connected to battery 107 via a connection line (wire) or electrical contact. In one embodiment, a buzzer 106 may be disposed on the bottom base 103 for coupling to the circuit board 104.

When the light emitting device of the light emitting member 102 is activated, the hair band device 100 is then emitting light for illumination.

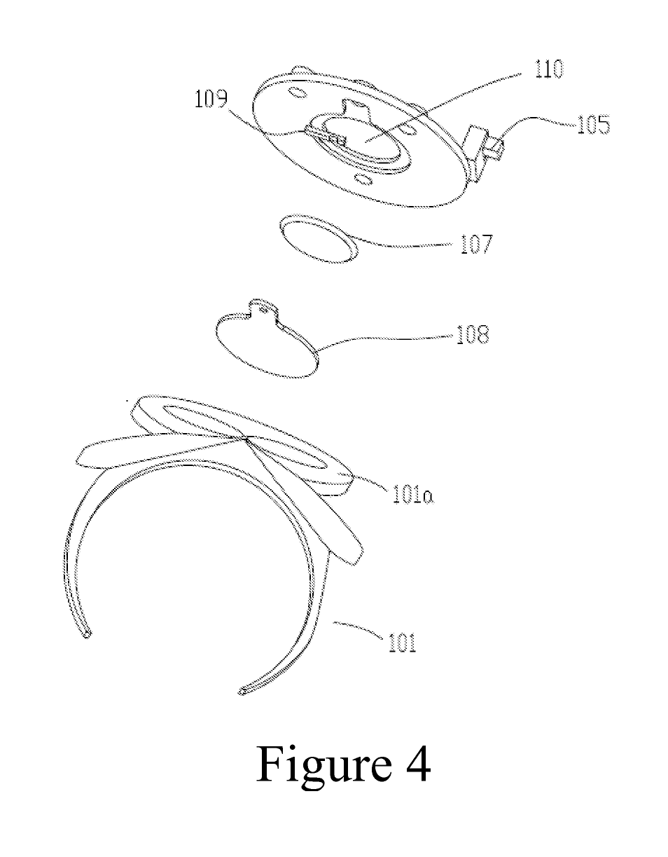

In one embodiment, the light emitting device is embedded on the base of the light emitting member 102. In one embodiment, the bottom base 103 defines/provides a battery compartment 110 configured to hold a miniature electric battery 107 which provides the energy for the light emitting device, shown in FIG. 4. In one embodiment, a metal sheet 109 is mounted on backside of the bottom base 103. For example, the metal sheet 109 locates within the battery compartment 110 for electrical connection with the battery 107 and the circuit board 104.

In one embodiment, control circuit on the circuit board 104 is used for controlling the operation of the multiple LEDs housed within the light emitting member (lamp) 102. Control circuit is typically an integrated circuit and is programmed with one or more patterns for flashing and/or maintaining illumination of LEDs. The switch 105 is used to power on and power off (power source providing for) the light emitting member (lamp) 102. The switch 105 may also be used to cycle through any number of different light patterns of the light emitting member 102. For example, each light emitting device (LED) of the light emitting member 102 may be turned on for a fraction of a second in the sequential order as they are positioned inside of light emitting member 102. It should be understood that the number of patterns possible is only limited by the number of LEDs that are used in the light emitting member 102.

In one embodiment, the hair band device 100 further comprises a rock switch for coupling to the circuit board 104 to determine electrical connection of the circuit board 104. The rock switch is for example ball-rolling switch, vibration ball switch or contact type vibration switch.

In another embodiment, the hair band device 100 further comprises a music IC for coupling to the circuit board 104. The rock switch is used to turn on electrical connection of the circuit board 104 to activate the music IC and LEDs of the light emitting member 102.

In this embodiment, the hair band body 101 is combined with (fixed to) the bottom base 103 and the light emitting member 102 to form the hair band device 100. For example, a bottom cover 108 may be combined with or detachable from the bottom base 103.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A hair band device having function of illumination, comprising:
a hair band body;
a light emitting member fixed on said hair band body, wherein said light emitting member comprises a base, a light emitting device for emitting light and a housing, wherein said light emitting device is disposed on said base and said housing with transparent or translucent property surrounds said light emitting device; and
a switch coupled to said light emitting member for selectively power on and power off said light emitting device of said light emitting member.

2. The hair band device of claim 1, further comprising a decoration unit disposed between said hair band body and said light emitting member.

3. The hair band device of claim 1, wherein said light emitting member is a lamp.

4. The hair band device of claim 1, wherein said light emitting device is a light emitting diode.

5. The hair band device of claim 1, further comprising a bottom base with a circuit board disposed on said bottom base, wherein said circuit board includes a control circuit for controlling said light emitting device.

6. The hair band device of claim 5, further comprising a buzzer disposed on said bottom base for coupling to said circuit board.

7. The hair band device of claim 5, further comprising a rock switch for coupling to said circuit board.

8. The hair band device of claim 7, wherein said rock switch is ball-rolling switch, vibration ball switch or contact type vibration switch.

9. The hair band device of claim 7, further comprising a music IC for coupling to said circuit board.

10. The hair band device of claim 9, wherein said control circuit is an integrated circuit and is programmed with one or more patterns for flashing and/or maintaining illumination of said light emitting devices.

11. The hair band device of claim 9, wherein said bottom base includes a battery compartment.

12. The hair band device of claim 11, further comprising a battery disposed on said battery compartment.

13. The hair band device of claim 11, further comprising a bottom cover combined with or detachable from said bottom base.

14. The hair band device of claim 5, further comprising a music IC for coupling to said circuit board.

15. The hair band device of claim 14, wherein said control circuit is an integrated circuit and is programmed with one or more patterns for flashing and/or maintaining illumination of said light emitting devices.

16. The hair band device of claim 14, wherein said bottom base includes a battery compartment.

17. The hair band device of claim 16, further comprising a battery disposed on said battery compartment.

18. The hair band device of claim 16, further comprising a bottom combined with or detachable from said bottom base.
